(19) United States
(12) Patent Application Publication
(10) Pub. No.: US 2022/0373356 A1
(43) Pub. Date: Nov. 24, 2022

(54) WHEEL WITH ODOMETER

(71) Applicant: CASTOMETER LIMITED, Glasgow (GB)

(72) Inventor: Stewart McKeown, Glasgow (GB)

(73) Assignee: CASTOMETER LIMITED, Glasgow (GB)

(21) Appl. No.: 17/773,957

(22) PCT Filed: Nov. 3, 2020
(86) PCT No.: PCT/GB2020/052787

§ 371 Date: May 3, 2022

(30) Foreign Application Priority Data
Nov. 4, 2019 (GB) 1916037.3

(51) Int. Cl. G01C 22/00; B60B 27/00

(52) U.S. Cl. CPC G01C 22/00; B60B 27/0068

(57) ABSTRACT

A wheel is illustrated and described. The wheel comprises an odometer, the odometer being located within the wheel and including a gear train. The gear train comprises a drive gear and at least one indicator gear. The drive gear is configured to be operable by a striking member. The at least one indicator gear includes an indicator device. The indicator device is configured to indicate the distance travelled by the wheel during use.

### FIELD OF THE INVENTION

The present invention relates to a wheel, particularly, but not exclusively, a wheel for a wheeled vehicle, a wheeled vehicle, and a method of operative the same.

### BACKGROUND TO THE INVENTION

A concern for retailers, such as supermarkets, and the like, is the accuracy of determining the exact trolley fleet size any particular store should operate with. Owing to the high cost of individual trolleys, it is a key area of financial and operational concern. The following questions are often raised by retailers.

1. How many trolleys should I purchase and place into operation for a new store? What data can I use to determine this?

Many retailers use similar methods to facilitate this answer, such as square footage of store, checkout quantity, product lines and anticipated footfall. It is never known how successful or busy a new store will be, and these data points are all the retailer can refer to, and take a calculated guess at the fleet size required.

2. How do I know that I haven't overstocked a specific store with trolleys?—and they are simply not being used, and could be used at another store?

This is a main financial concern for retailers, as asset purchases to allow trading—are obviously fundamental, but over-purchasing is not good practice and reduces margin. There is also the issue of ‘retail space’—as in, trolley corals or bays must be sited in car parks to allow customer ease of access to the trolleys, at shopping commencement and end, and these bays take up the space of between 2 and 6 car parking spaces, which is 2 to 6 customers who cannot park at busy times and bring business to the store.

3. How do I know if a store has too little trolleys?—and customers simply walk/drive away, as they could not obtain a suitable trolley?

Again, this is a major problem for retailers, as customers who simply ‘walk away’ are usually not mindful to go into the store, or contact at a later date—to provide this information, so the result is that these figures are simply unknown—but the loss of sales is very real, and all retailers spend a very high level of resource to entice shoppers to their stores, and to lose them whilst in the car park, is extremely problematic.

When a customer does abandon a shopping trip due to no suitable trolleys available, then they most likely will go to a competitor's store, and could then change loyalties for a lifetime. For this reason, retailers ‘top up’ key stores pre-Christmas every year, to help stem this problem, and capture as much business as possible in this peak trading time.

Track and trace solutions to monitor the movement of wheeled vehicles is known, with such solutions using GPS devices, sensors and RFID technology. However, such solutions require electrical power and are time consuming and expensive to install and maintain. Such solutions are also often unreliable, other electronic devices and communication systems in the vicinity of the devices can affect their operation, with operation in wet weather also being problematic.

The inventor has appreciated the shortcomings in known track and trace systems for monitoring the usage of wheeled vehicles.

According to a first aspect of the present invention there is provided a wheel, the wheel comprising:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The wheel may be configured to receive an axle. The wheel may have a hub, the hub being configured to receive an axle. The wheel may rotate about the axle. The wheel may include a bearing. The bearing may support the wheel on the axle. The bearing may include an inner race/housing and an outer race/housing. Ball bearings may be located between the inner race/housing and the outer race/housing. The axle may be supported by the inner race/housing of the bearing. The wheel may have a lateral axis. The lateral axis may be the axis of rotation of the wheel, or the rotational axis of the wheel.

The wheel may be configured to be connectable to a fork. The wheel may be connectable to the fork via the axle. The fork may be attachable to the axle. The axle may be connectable to the fork. The fork may include two legs, each leg being connectable to an opposite side of the wheel. The fork may be a swivel fork. The fork may be a fixed fork, i.e., a non-swivel fork. The fork may be configured to be rotatable relative to a mounting portion thereof. The fork may be configured to be fixed to a mounting portion thereof. The mounting portion of the fork may be configured to allow the fork to be mounted, or attached, to an object, such as a trolley, shopping trolley, cage, cart, bed, chair, platform, ladder, or the like. The fork may be configured to be rotatable relative to the mounting portion. The fork may rotate about a longitudinal axis, or vertical axis. The longitudinal/vertical axis may be perpendicular to the rotational axis of the wheel. The wheel and swivel fork may together form a caster/castor. The wheel may be a caster/castor wheel.

The wheel may include a body portion. The body portion may be substantially cylindrical. The body portion may be disc-shaped. The body portion may be substantially the shape of an annular disc. The body portion may be supported by the bearing. The wheel may include a ground-engaging portion. The ground-engaging portion may be located around the outer circumference of the wheel. The ground-engaging portion may be, or include, a tread portion. The wheel may include a tread. The tread may be a rubber tread.

The body portion of the wheel may include a cavity. The cavity may be located within the body portion of the wheel. The cavity may be a hollowed-out portion of the body portion. The cavity may be a void, or a void space, in the body portion of the wheel. The cavity may be the shape of at least part of an annular disc. The cavity may be the shape of an annular disc. The cavity may be an annular disc-shaped void. The cavity may be an annular disc-shaped void, or opening. The cavity may be a channel portion. The channel portion may be substantially circular in shape.

The cavity may at least partially surround the rotational axis of the wheel. The cavity may surround the rotational axis of the wheel. The axis of rotation of the cavity may be coincident with the rotational axis of the wheel.

The cavity may be located on one side of the wheel. The cavity may be located on a side portion of the wheel.

The wheel may be between approximately 75 mm and 300 mm in diameter. The wheel may have a diameter of approximately 120 mm to 130 mm. The wheel may have an approximate diameter of 125 mm. The wheel may have a circumference between approximately 235 mm and 945 mm. The wheel may have a circumference of approximately 38.2 mm to 41.4 mm. The wheel may have a circumference of approximately 40 mm.

The cavity may have a depth of between approximately 5 mm to 15 mm. The cavity may have a depth of approximately 1 cm.

The cavity may have a width of between approximately 25 mm to 35 mm. The cavity may have a width of approximately 3 cm.

The wheel may be made of plastic. The wheel may be made of a plastic material. The body portion of the wheel may be made of plastic. The body portion of the wheel may be made of a plastic material. The bearing may be made of metal.

The wheel may be suitable for use with a trolley, such as a shopping trolley, or the like. The wheel may be a shopping trolley wheel.

The wheel may further comprise a cover member. The cover member may cover the cavity. The cover member may be transparent. The cover member may be opaque. The cover member may be translucent. The cover member may be fixedly attachable to the body portion of the wheel.

The odometer may be at least partially located within the wheel. The gear train may be at least partially located within the wheel.

The odometer may constantly record the distance travelled by the wheel.

The odometer may be located within a housing of the wheel. The odometer may be located within the body portion of the wheel. The odometer may be located entirely within the body portion of the wheel. The odometer may be located within the cavity of the body portion of the wheel. The odometer may be located entirely within the cavity of the body portion of the wheel. The gear train of the odometer may be located within the body portion of the wheel. The gear train of the odometer may be located entirely within the body portion of the wheel. The odometer may be located within the cavity of the body portion of the wheel. The gear train of the odometer may be located entirely within the cavity of the body portion of the wheel.

The odometer may be located between the axis of rotation of the wheel and the outer circumference. The gear train may be located between the axis of rotation of the wheel and the outer circumference. The odometer may be located between the centre of the wheel and the outer circumference. The gear train may be located between the centre of the wheel and the outer circumference.

The gear train of the odometer may include a plurality of gears. The gear train may include between two and fifteen gears.

The gears of the gear train may rotate relative to the wheel. The gears of the gear train may rotate relative to the body portion of the wheel. The gears of the gear train may be rotatably mounted/mountable to the wheel. The gears of the gear train may be rotatably mounted/mountable to the body portion of the wheel.

The gear train may include between two and six indicator gears. The gear train may include two, or more, indicator gears. The gear train may include four, or more, indicator gears.

The gears of the gear train may be arranged sequentially. The gears of the gear train may be arranged in series. The gear train may be a series of gears. The gears of the gear train may be arranged in a line. The gears of the gear train may be arranged in a curved line. The gears of the gear train may be arranged in a circular line. The gears of the gear train may be arranged in a circular arrangement. The gears of the gear train may follow the path of a circle. The gears of the gear train may at least partially surround the rotational axis of the wheel. The gears of the gear train may at least partially follow the outer, or inner, circumference of the wheel. Operation of the drive gear turns the indicator gears.

The gear train may be substantially arranged in a plane. The gear train may be substantially planar. The gear train may be a planar gear train.

The gears of the gear train may be spur gears. The gears of the gear train may be disc/disk gears. The gears of the gear train may be gear wheels.

The gears of the gear train may be gear shafts. The gears of the gear train may be mounted on a shaft. Each gear of the gear train may be mounted on a shaft. Each shaft may rotate relative to the wheel. Each shaft may rotate relative to the body portion of the wheel.

Each gear of the gear train may rotate about an axis. Each gear of the gear train may have a rotational axis. The rotational axis of each gear may be parallel to the rotational axis of the wheel. The rotational axis of each gear may be substantially parallel to the rotational axis of the wheel.

Each gear of the gear train may be mounted/mountable on a support member. The support member may be attached to, or formed with, the body portion of the wheel. Each gear of the gear train may be rotatably mounted on the support member. Each gear of the gear train may be configured to receive at least a portion of the support member therethrough, such that the gear may rotate with respect to the support member. Each gear of the gear train may include an aperture, or opening, the aperture, or opening, being configured to receive the support member. The aperture, or opening, may be circular.

Each gear shaft may be mounted/mountable on a support member. The support member may be attached to, or formed with, the body portion of the wheel. Each gear shaft of the gear train may be rotatably mounted on the support member. Each gear shaft of the gear train may be configured to receive at least a portion of the support member therethrough, such that the gear shaft may rotate with respect to the support member. Each gear shaft of the gear train may be configured to receive the support member. Each gear shaft may be a hollow cylinder. Each gear shaft may include a cylindrical passage that extends the length of the shaft.

The support members may be arranged perpendicularly to the body portion of the wheel. The support members may be arranged perpendicularly to a portion of the cavity of the wheel.

The support members may be located within the cavity of the body portion.

The support members may be substantially cylindrical members. The support members may be formed integrally with the body portion of the wheel. The support members may be attached to the body portion of the wheel. The support members may be cylindrical protrusions.

Each support member may be a pin. The support members may be pins. The support members may be pin members, or the like.

Each gear, or gear shaft, of the gear train may include a locking device, or securing device. The locking device, or securing device, may be configured to retain the gear, or gear shaft, in place. The locking device, or securing device, may be configured to retain the gear, or gear shaft, in place with respect to the body portion of the wheel. The locking device, or securing device, may be configured to retain the gear, or gear shaft, in place with respect to the support member of the wheel.

The locking device, or securing device, may be a collar, disc, annular disc, or ring, member. The locking device, or securing device, may engage with the wheel with an interference fit. The locking device, or securing device, may engage with the support member with an interference fit.

The drive gear may be a spur gear. The drive gear may include between five and fifteen gear teeth. The drive gear may include ten gear teeth.

The teeth of the drive gear may be non-involute. The teeth of the drive gear may be involute.

The drive gear may be configured to be operable by a striking member striking a gear tooth. The drive gear may be configured to be operable by a striking member striking a face of a gear tooth.

The drive gear may be configured such that it partially rotates when struck by the striking member. The drive gear may be configured such that striking of a gear tooth by the striking member rotates the drive gear by an amount that presents the subsequent, or next, gear tooth for striking. In this arrangement, the striking member strikes each gear tooth of the drive gear as the gear rotates.

The drive gear may be configured such that consecutive gear teeth are struck by the striking member. The striking member may strike each gear tooth of the drive gear. The striking member may strike each gear tooth of the drive gear consecutively.

The striking member may strike the drive gear once per revolution of the wheel. The striking member may strike the drive gear once per revolution of the wheel, in use.

The wheel may further comprise a striking device. The striking device may include a striking member. The striking member being configured to strike the drive gear in use. The striking device may be engageable with the wheel.

The striking device may be rotatably mounted/mountable to the wheel. The striking device may be rotatably mounted/mountable to the body portion of the wheel. The striking device may be rotatably engageable with the wheel. The striking device may be rotatably engageable with the body portion of the wheel. The striking member of the striking device may be configured to strike the drive gear of the gear train once per relative revolution between the wheel and the striking device in use.

The striking device may further include an abutment member. The abutment member may be configured such that, in use, it may abut against an object to which the wheel is attached. The abutment member may be configured such that, in use, it may abut against an object to which the wheel is attached to allow the wheel to rotate relative to the striking device. In this arrangement, the wheel rotates with respect to the striking device. That is, the wheel rotates around the striking device. In this arrangement, the striking device is held in place (abutting against the object) and the wheel rotates about the striking device. The drive gear of the gear train is struck by the striking member of the striking device once per revolution of the wheel. The object may be a fork. The object may be a swivel fork. The fork may be a fixed fork, i.e., a non-swivel fork. In this arrangement, the abutment member of the striking device abuts a portion of the fork, such that the striking device is prevented from rotating with respect to the fork, and the wheel is free to rotate about the striking device.

The striking device may be configured such that it may be attachable to an object. The striking device may be configured such that it may be attachable to an object, such that, in use, the wheel rotates with respect to the striking device. In this arrangement, the striking device is fixed to the object and the wheel rotates about the striking device. The drive gear of the gear train is struck by the striking member of the striking device once per revolution of the wheel. The object may be a fork. The object may be a swivel fork. The fork may be a fixed fork, i.e., a non-swivel fork. In this arrangement, the striking device is prevented from rotating with respect to the fork, and the wheel is free to rotate about the striking device.

The striking device may include a body portion. The body portion may include the striking member. The body portion may include the abutment member. The body portion may include the striking member and the abutment member. The body portion may be a disc member. The body portion may be an annular disc. The striking member and the abutment member may be protrusions, or protruding members. The striking member may be a gear tooth. The striking member may have a similar shape as a gear tooth of a gear.

The striking member may be located on an edge portion of the body portion of the striking device. The striking member may be located on a circumferential edge portion of the body portion of the striking device.

The abutment member may be located on an upper surface of the body portion of the striking device. The abutment member may protrude from an upper surface of the body portion of the striking device. The abutment member may be an elongate member. The abutment member may be partially annular in shape. The abutment member may have the shape of a partial annular disc.

The striking device may be configured to receive the axle. The striking device may rotate about the axle. The striking device may include an aperture, the aperture may receive the axle therethrough. The striking device may rotate about the axis of rotation of the wheel. The striking device may be located on a side portion of the wheel.

The striking device may include a cylindrical support portion. The cylindrical support portion may be attachable to, or formed with, the body portion. The cylindrical support portion may be configured to receive the axle therethrough. In this arrangement the body portion may be a flange portion to the cylindrical support portion.

The gear train may further comprise one or more intermediate gears. The one or more intermediate gears may be located between the drive gear and the at least one indicator gear. The one or more intermediate gears may be located between the drive gear and the first at least one indicator gear.

The intermediate gears may be reduction gears.

The one or more intermediate gears may be configured to reduce number of revolutions of the drive gear that are transmitted to the at least one indicator gear.

The gear train may include two, or three, or more intermediate gears.

The gear ratio between the drive gear and the at least one indicator gear may be greater than one. The gear ratio between the drive gear and the at least one indicator gear may be ten (10:1). The gear ratio between the drive gear and the at least one indicator gear may be between five and fifteen.

The gear ratio between each indicator gear may be greater than one. The gear ratio between each indicator gear may be ten (10:1). The gear ratio between each indicator gear may be between five and fifteen.

The gear ratio between the drive gear and the, or each, intermediate gear may be greater than one. The gear ratio between the drive gear and the, or each, intermediate gear may be ten (10:1). The gear ratio between the drive gear and the, or each, intermediate gear may be between five and fifteen. The gear ratio between the drive gear and the, or each, intermediate gear may be one (1:1), or greater than one.

The gear ratio between each intermediate gear may be one (1:1), or greater than one. The gear ratio between each intermediate gear may be between five and fifteen.

The gear train of the odometer may comprise: a drive gear, three intermediate gears, and four indicator gears. The gears may be arranged sequentially. The gears may be arranged consecutively.

The gear ratio between the drive gear and the first intermediate gear may be between five and fifteen. The gear ratio between the first intermediate gear and the second intermediate gear may be between five and fifteen. The gear ratio between the second intermediate gear and the third intermediate gear may be between five and fifteen. The gear ratio between the third intermediate gear and the first indicator gear may be between five and fifteen. The gear ratio between the first indicator gear and the second indicator gear may be between five and fifteen. The gear ratio between the second indicator gear and the third indicator gear may be between five and fifteen. The gear ratio between the third indicator gear and the fourth indicator gear may be between five and fifteen.

The gear ratio between the drive gear and the first intermediate gear may be ten (10:1). The gear ratio between the first intermediate gear and the second intermediate gear may be one (1:1). The gear ratio between the second intermediate gear and the third intermediate gear may be ten (10:1). The gear ratio between the third intermediate gear and the first indicator gear may be ten (10:1). The gear ratio between the first indicator gear and the second indicator gear may be ten (10:1). The gear ratio between the second indicator gear and the third indicator gear may be ten (10:1). The gear ratio between the third indicator gear and the fourth indicator gear may be ten (10:1).

The drive gear may be a gear shaft. The gear shaft may have a first gear and a second gear. The first gear may be operable by the striking member. The first gear may include ten gear teeth. The second gear may include one gear tooth. The second gear may drive the first intermediate gear. The first and second gears may be spaced apart in the longitudinal direction of the gear shaft.

The first intermediate gear may be a gear shaft. The gear shaft may have a gear. The gear of the gear shaft may have ten gear teeth. The gear may drive the second intermediate gear.

The second intermediate gear may be a gear shaft. The gear shaft may have a first gear and a second gear. The first gear may be driven by the gear of the first intermediate gear shaft. The first gear may include ten gear teeth. The second gear may include one gear tooth. The second gear may drive the third intermediate gear. The first and second gears may be spaced apart in the longitudinal direction of the gear shaft.

The third intermediate gear may be a gear shaft. The gear shaft may have a first gear and a second gear. The first gear may be driven by the second gear of the second intermediate gear shaft. The first gear may include ten gear teeth. The second gear may include one gear tooth. The second gear may drive the first indicator gear. The first and second gears may be spaced apart in the longitudinal direction of the gear shaft.

The first indicator gear may be a gear shaft. The gear shaft may have a first gear and a second gear. The first gear may be driven by the second gear of the third intermediate gear shaft. The first gear may include ten gear teeth. The second gear may include one gear tooth. The second gear may drive the second indicator gear. The first and second gears may be spaced apart in the longitudinal direction of the gear shaft.

The second indicator gear may be a gear shaft. The gear shaft may have a first gear and a second gear. The first gear may be driven by the second gear of the first indicator gear. The first gear may include ten gear teeth. The second gear may include one gear tooth. The second gear may drive the third indicator gear. The first and second gears may be spaced apart in the longitudinal direction of the gear shaft.

The third indicator gear may be a gear shaft. The gear shaft may have a first gear and a second gear. The first gear may be driven by the second gear of the second indicator gear. The first gear may include ten gear teeth. The second gear may include one gear tooth. The second gear may drive the fourth indicator gear. The first and second gears may be spaced apart in the longitudinal direction of the gear shaft.

The fourth indicator gear may be a gear shaft. The gear shaft may have a gear. The gear may be driven by the second gear of the third indicator gear. The gear may include ten gear teeth.

The gear shafts may be integrally formed. The gear shafts may be formed in two parts, the two parts being configured to interlock and rotate as one when driven.

The first and second gears of the drive gear, intermediate gears, and indicator gears may be integrally formed.

The gears, or gear shafts, of the gear train may be in discontinuous contact. That is, the gears, or gear shafts, of the gear train may be arranged such that the gears, or gear shafts, do not all rotate at the same time. Operation of each of the gears, or gear shafts, after the drive gear is dependent upon a single tooth of the driving gear striking the adjacent gear, which is once per revolution of that gear.

The indicator device may represent the distance travelled by the wheel during use. The indicator device may be configured to represent the distance travelled by the wheel during use. The indicator device may include a display, the display representing the distance travelled by the wheel during use. The indicator device may represent the distance travelled by the wheel in a code form. The code may be decipherable, or translated, to provide the distance travelled by the wheel in units, such as meters, kilometres, etc. The indicator device may directly, or indirectly, indicate the distance travelled by the wheel during use.

The indicator device may be configured to indicate the position of the gear relative to the body portion of the wheel. The indicator device may be configured to indicate the position of each gear tooth of the gear relative to the body portion of the wheel.

The indicator device may associate an identification marker, such as an alphanumeric character, with each gear tooth of the gear. The indicator device may indicate the number of revolutions the gear has undertaken with respect to the body portion of the wheel. The identification marker may indicate the number of revolutions the gear has undertaken. Each gear tooth of the gear may include an identification marker.

The identification marker is representative of the distance travelled by the wheel during use. The distance travelled by the wheel may be determined by an algorithm that converts the identification marker to a distance.

The indicator device may include a disc member, the disc member being marked with the identification markers. The disc member may be attachable to the gear, or support member to which the gear may be mounted. The disc member may be numbered from 0 to 9, each number being associated with a gear tooth. The disc member may have numbers, or sequential characters, associated with each gear tooth of the gear.

The indicator device and the cover member of the wheel may be arranged such that the identification marker is visible through a portion of the cover member. The indicator device and the cover member of the wheel may be arranged such that the identification marker is visible through an aperture, or window, of the cover member.

Each indicator gear may include an indicator device. The identification marker of each gear is representative of the distance travelled by the wheel during use. The distance travelled by the wheel may be determined by an algorithm that converts the identification markers to a distance. The identification marker(s) may be converted to a distance travelled by the wheel by an algorithm, function, or the like.

The wheel may further comprise a further identification device. The identification device being configured to identify one or more parameters, or pieces of information pertaining to the wheel. The identification device may be adjustable, such that a plurality of parameters or pieces of information pertaining to the wheel may identified. The identification device may include a plurality of symbols, characters, markers, or the like, each of which is representative of a parameter, or piece of information pertaining to the wheel.

The identification device may be located within the wheel. The identification device may be located within the cavity of the wheel.

The identification device may include one or more adjustment members. The one or more adjustment members may be operable to change the plurality of symbols, characters, markers, or the like.

The one or more adjustment members may be operable through the cover member of the wheel. The one or more adjustment members may be operable through an aperture, or apertures, of the cover member of the wheel. The one or more adjustment members may be rotatable members. The one or more adjustment members may be wheel members.

The odometer may be configured to read up to approximately 4,000 km before resetting to zero.

According to a second aspect of the present invention there is provided a wheel, the wheel comprising:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to represent the distance travelled by the wheel during use.

The indicator device may directly, or indirectly, represent the distance travelled by the wheel during use.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided a wheel, the wheel comprising:
a distance measuring device, the distance measuring device being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The distance measuring device may be an odometer. The distance measuring device may be configured to measure the distance travelled by the wheel in use.

Embodiments of the third aspect of the present invention may include one or more features of the first or second aspects of the present invention or their embodiments. Similarly, embodiments of the first or second aspects of the present invention may include one or more features of the third aspect of the present invention or its embodiments.

According to a fourth aspect of the present invention there is provided a vehicle comprising a wheel, the wheel comprising:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The vehicle may comprise at least three other wheels, the other wheels not including an odometer.

The vehicle may be a conveyance or transport vehicle. The vehicle may be configured to transport a load, or loads. The vehicle may be configured to carry objects, or loads. The vehicle may be a trolley, cart, shopping trolley, shopping cart, or the like.

The vehicle may include four wheels, one of the wheels may be a wheel according to the fourth aspect of the present invention.

Embodiments of the fourth aspect of the present invention may include one or more features of the first, second or third aspects of the present invention or their embodiments. Similarly, embodiments of the first, second or third aspects of the present invention may include one or more features of the fourth aspect of the present invention or its embodiments.

According to a fifth aspect of the present invention there is provided a wheeled vehicle, wherein a wheel of the wheeled vehicle comprises:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The wheeled vehicle may comprise at least three other wheels, the other wheels not including an odometer.

Embodiments of the fifth aspect of the present invention may include one or more features of the first, second, third, or fourth aspects of the present invention or their embodiments. Similarly, embodiments of the first, second, third or fourth aspects of the present invention may include one or more features of the fifth aspect of the present invention or its embodiments.

According to a sixth aspect of the present invention there is provided a trolley comprising a wheel, the wheel comprising:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The trolley may comprise at least three other wheels, the other wheels not including an odometer.

Embodiments of the sixth aspect of the present invention may include one or more features of the first, second, third, fourth, or fifth aspects of the present invention or their embodiments. Similarly, embodiments of the first, second, third, fourth, or fifth aspects of the present invention may include one or more features of the sixth aspect of the present invention or its embodiments.

According to a seventh aspect of the present invention there is provided a wheel, the wheel comprising:
an odometer, the odometer being located within the wheel.

The odometer may include a gear train, the gear train comprising a drive gear; and at least one indicator gear, wherein the drive gear is configured to be operable by a striking member, and the at least one indicator gear includes an indicator device, the indicator device being configured to indicate the distance travelled by the wheel during use.

Embodiments of the seventh aspect of the present invention may include one or more features of the first, second, third, fourth, fifth, or sixth aspects of the present invention or their embodiments. Similarly, embodiments of the first, second, third, fourth, fifth, or sixth aspects of the present invention may include one or more features of the seventh aspect of the present invention or its embodiments.

According to an eighth aspect of the present invention there is provided
a wheel, the wheel comprising:
a mechanical odometer, the mechanical odometer being located within the wheel.

The odometer may include a gear train, the gear train comprising a drive gear; and at least one indicator gear, wherein the drive gear is configured to be operable by a striking member, and the at least one indicator gear includes an indicator device, the indicator device being configured to indicate the distance travelled by the wheel during use.

Embodiments of the eighth aspect of the present invention may include one or more features of the first, second, third, fourth, fifth, sixth, or seventh aspects of the present invention or their embodiments. Similarly, embodiments of the first, second, third, fourth, fifth, sixth, or seventh aspects of the present invention may include one or more features of the eighth aspect of the present invention or its embodiments.

According to a ninth aspect of the present invention there is provided a wheel, the wheel comprising:
a cavity located within a body portion of the wheel; and
an odometer, the odometer being located within the cavity.

The odometer may be a mechanical odometer. The odometer may include a gear train, the gear train comprising a drive gear; and at least one indicator gear, wherein the drive gear is configured to be operable by a striking member, and the at least one indicator gear includes an indicator device, the indicator device being configured to indicate the distance travelled by the wheel during use.

Embodiments of the ninth aspect of the present invention may include one or more features of the first, second, third, fourth, fifth, sixth, seventh, or eighth aspects of the present invention or their embodiments. Similarly, embodiments of the first, second, third, fourth, fifth, sixth, seventh, or eighth aspects of the present invention may include one or more features of the ninth aspect of the present invention or its embodiments.

According to a tenth aspect of the present invention there is provided a method of determining the distance travelled by a vehicle, the method comprising the steps of:
providing a vehicle, wherein a wheel of the vehicle includes an odometer located within the wheel, the odometer including an indicator device configured to indicate the distance travelled by the wheel during use;
recording a first reading of the odometer;
recording a second reading of the odometer, the second reading being carried out after a predetermined time interval; and
determining the distance travelled by the wheel between the first reading and the second reading.

The vehicle may comprise at least three other wheels, the other wheels not including an odometer.

The odometer may be located within a body portion of the wheel.

The odometer including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The vehicle may be a conveyance or transport vehicle. The vehicle may be configured to transport a load, or loads. The vehicle may be configured to carry objects, or loads. The vehicle may be a trolley, cart, shopping trolley, shopping cart, or the like.

The vehicle may include four wheels, one of the wheels may be a wheel according to the fourth aspect of the present invention.

The vehicle may be a wheeled vehicle.

The odometer may be a mechanical odometer.

The odometer may be located within a cavity located within a body portion of the wheel.

The indicator device may represent the distance travelled by the wheel during use. The indicator device may be configured to represent the distance travelled by the wheel during use. The indicator device may include a display, the display representing the distance travelled by the wheel during use. The indicator device may represent the distance travelled by the wheel in a code form. The code may be decipherable, or translated, to provide the distance travelled by the wheel in units, such as meters, kilometres, etc. The indicator device may directly, or indirectly, indicate the distance travelled by the wheel during use.

The method may comprise the further step of decoding, deciphering, or translating, the reading from the odometer to obtain the distance travelled by the wheel in units, such as meters, kilometres, etc.

The wheel may further comprise a further identification device. The identification device being configured to identify one or more parameters, or pieces of information pertaining to the wheel. The identification device may be adjustable, such that a plurality of parameters or pieces of information pertaining to the wheel may identified. The identification device may include a plurality of symbols, characters, markers, or the like, each of which is representative of a parameter, or piece of information pertaining to the wheel.

The method may comprise the further step of operating the further indication device to adjust the one or more parameters, or pieces of information pertaining to the wheel.

Embodiments of the tenth aspect of the present invention may include one or more features of the first, second, third, fourth, fifth, sixth, seventh, eighth, or ninth aspects of the present invention or their embodiments. Similarly, embodiments of the first, second, third, fourth, fifth, sixth, seventh, eighth, or ninth aspects of the present invention may include one or more features of the tenth aspect of the present invention or its embodiments.

According to an eleventh aspect of the present invention there is provided a method of determining the distance travelled by a plurality of vehicles, the method comprising the steps of:
providing a plurality of vehicles, wherein a wheel of each of the vehicles includes an odometer located within the wheel, the odometer including an indicator device configured to indicate the distance travelled by the wheel during use;
recording a first reading of the odometer of each vehicle;
recording a second reading of the odometer of each vehicle, the second reading being carried out after a predetermined time interval; and
determining the distance travelled by the wheel of each vehicle between the first reading and the second reading.

Embodiments of the eleventh aspect of the present invention may include one or more features of the first, second, third, fourth, fifth, sixth, seventh, eighth, ninth, or tenth aspects of the present invention or their embodiments. Similarly, embodiments of the first, second, third, fourth, fifth, sixth, seventh, eighth, ninth, or tenth aspects of the present invention may include one or more features of the eleventh aspect of the present invention or its embodiments.

According to a twelfth aspect of the present invention there is provided a wheeled vehicle, wherein a wheel of the wheeled vehicle comprises:
an odometer, the odometer being located within the wheel.

The wheeled vehicle may be a conveyance or transport vehicle. The vehicle may be configured to transport a load, or loads. The vehicle may be configured to carry objects, or loads. The vehicle may be a trolley, cart, shopping trolley, shopping cart, or the like.

The wheeled vehicle may comprise at least three other wheels, the other wheels not including an odometer.

The odometer may be a mechanical odometer. The odometer may include a gear train, the gear train comprising a drive gear; and at least one indicator gear, wherein the drive gear is configured to be operable by a striking member, and the at least one indicator gear includes an indicator device, the indicator device being configured to indicate the distance travelled by the wheel during use.

Embodiments of the twelfth aspect of the present invention may include one or more features of the first, second, third, fourth, fifth, sixth, seventh, eighth, ninth, tenth, or eleventh aspects of the present invention or their embodiments. Similarly, embodiments of the first, second, third, fourth, fifth, sixth, seventh, eighth, ninth, tenth, or eleventh aspects of the present invention may include one or more features of the twelfth aspect of the present invention or its embodiments.

According to a thirteenth aspect of the present invention there is provided
a caster, the caster comprising a fork and a wheel, the fork being attachable to the wheel, and the wheel comprising:
an odometer, the odometer being located within the wheel and including a gear train, the gear train comprising:
a drive gear; and
at least one indicator gear,

wherein the drive gear is configured to be operable by a striking member, and the at least one indicator gear includes an indicator device, the indicator device being configured to indicate the distance travelled by the wheel during use.

The fork may be a swivel fork. The fork may be a fixed fork, i.e., a non-swivel fork.

Embodiments of the thirteenth aspect of the present invention may include one or more features of the first, second, third, fourth, fifth, sixth, seventh, eighth, ninth, tenth, eleventh, or twelfth aspects of the present invention or their embodiments. Similarly, embodiments of the first, second, third, fourth, fifth, sixth, seventh, eighth, ninth, tenth, eleventh, or twelfth aspects of the present invention may include one or more features of the thirteenth aspect of the present invention or its embodiments.

### BRIEF DESCRIPTION OF THE DRAWINGS

Embodiments of the invention will now be described, by way of example only, with reference to the drawings, in which:

FIG. 1 is a side view of the wheel of the present invention;

FIG. 2 is a perspective view of the wheel of FIG. 1;

FIG. 3 is a side view of the wheel of FIG. 1 without the striking device;

FIG. 4 is a detail view of the drive gear of the odometer;

FIG. 5 is a detail view of the intermediate gears of the odometer;

FIG. 6 is a detail view of the intermediate gears of the odometer and a first indicator gear;

FIG. 7 is a detail view of a first and second indicator gear;

FIG. 8 is a detail view of second and third indicator gear;

FIG. 9 is a detail view of a third and fourth indicator gear;

FIG. 10 is a perspective view of the striking device;

FIG. 11 is a side view of the wheel of FIG. 1 assembled with a swivel fork;

FIG. 12 is a perspective view of the wheel and swivel fork of FIG. 11; and

FIG. 13 is a side view of a wheeled vehicle including the wheel of the present invention.

### DESCRIPTION OF PREFERRED EMBODIMENTS

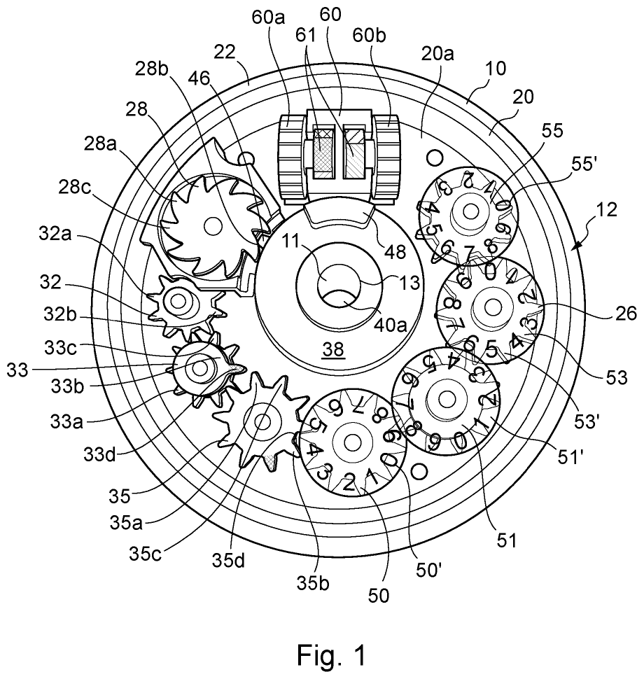

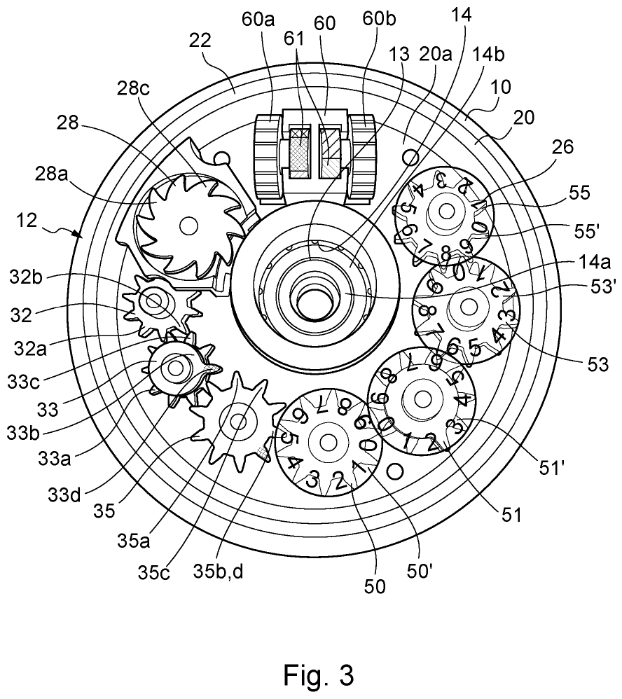

With reference to FIGS. 1 to 3, a wheel 10 according to the present invention is illustrated. The wheel 10 includes an odometer 12 (an example of a distance measuring device) located within the wheel 10, as described further below, and in accordance with the present invention. The odometer 12 is “inbuilt” with the wheel 10.

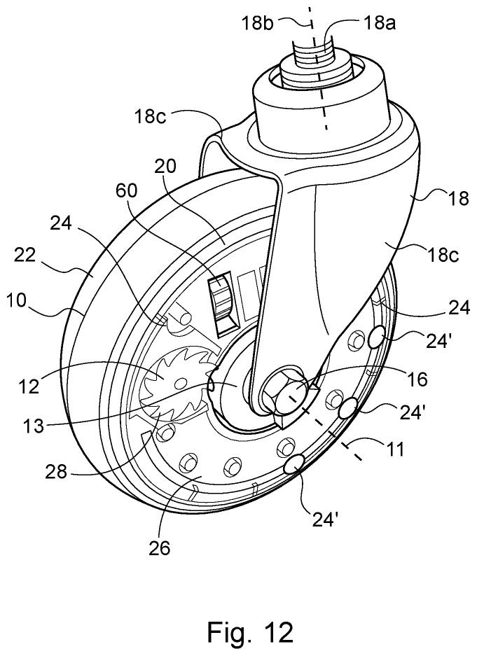

The wheel 10 incudes a hub portion 13, which includes a bearing 14. The bearing 14 is configured to receive an axle 16 (FIGS. 11 and 12), such that the wheel 10 may rotate about the axle 16. The bearing 14 supports the wheel 10 on the axle 16. The bearing 14 includes an inner race/housing 14a and an outer race/housing 14b. The wheel 10 rotates about a lateral axis 11. The lateral axis 11 is the rotational axis of the wheel 10.

With reference to FIGS. 11 and 12, and described further below, the wheel 10 is connectable to a fork 18 (an example of an object to with the wheel 10 is attached). The fork 18 may be mounted to, or receive, the axle 16 therethrough. In the embodiment illustrated and described here the fork 18 is a swivel fork, and is therefore capable of rotating about a mounting portion 18a thereof. However, it should be appreciated that the fork may be a fixed fork. The mounting portion 18a being configured to allow the fork 18 to be attached to an object, such as a trolley, shopping trolley, cage, cart, bed, chair, platform, ladder, or the like. The fork 18 may rotate about a longitudinal/vertical axis 18b, the longitudinal/vertical axis 18a being perpendicular to the lateral axis 11 of the wheel 10. The fork 18 includes two legs 18c, each leg 18c being connectable to an opposite side of the wheel 10. The wheel 10 and fork 18 arrangement may be considered as a caster/castor wheel.

The wheel 10 includes a body portion 20, which in the embodiment illustrated and described here is a disc-shaped member. The body portion 20 is supported by the hub 13. The wheel 10 also includes a tread portion 22 (an example of a ground-engaging portion) that is located around the outer circumference of the wheel 10. The tread portion 22 may be a rubber tread, or the like.

The body portion 20 includes a cavity 20a on one side of the wheel 10. The cavity 20a is substantially the shape of an annular disc and surrounds the hub 13. The cavity 20a thus surrounds the rotational axis 11 of the wheel 10. The axis of rotation of the cavity 20a is coincident with the rotational axis 11 of the wheel 10. The cavity 20a may be considered as a channel portion.

In the embodiment illustrated and described here the wheel 10 has an approximate diameter of 125 mm and a circumference of approximately 40 mm. However, it should be appreciated that the wheel 10 may be larger or smaller than this, as required.

The cavity 20a has a depth of approximately 1 cm, and a width of approximately 3 cm. However, it should be appreciated that the cavity 20a may be larger or smaller than this, as required.

The body portion 20 may be made of plastic, the bearing 14 may be made of metal, and the tread portion may be made of rubber. The fork 18 may be made of metal.

As illustrated in FIGS. 11 and 12, the wheel 10 further comprises a cover member 24, which covers the odometer 12. The cover member 24 is fixedly attachable to the body portion 20 of the wheel 10 via screw members, or the like. In the embodiment illustrated and described here the cover member 24 is translucent. However, it should be appreciated that the cover member 24 may be transparent or opaque.

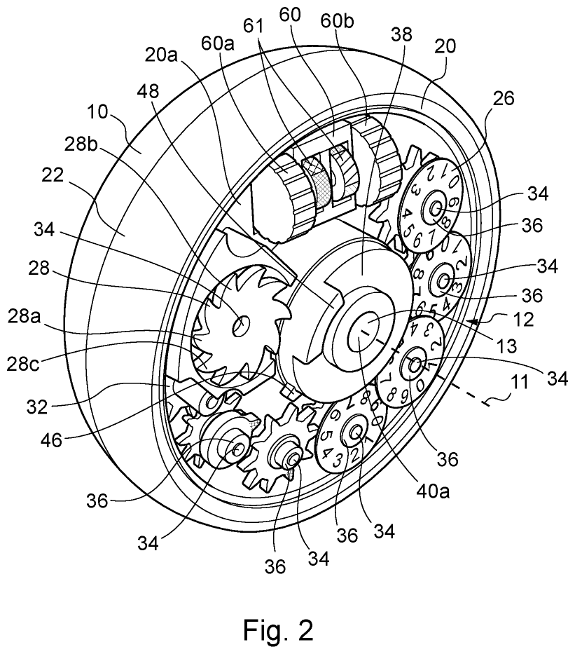

With reference to FIGS. 1 and 2, the odometer 12 is located within the wheel 10, i.e., the odometer 12 is located within the cavity 20a of the body portion 20 of the wheel 10.

The odometer 12 is a mechanical odometer and includes a gear train 26. In the embodiment illustrated and described here the gear train 26 includes a drive gear 28, four indicator gears 50, 51, 53, and 55, and three intermediate gears 32, 33 and 35. However, it should be appreciated that other gear train arrangements may be possible. The gear train 26 is therefore also located within the wheel 10.

As illustrated, the gear train 26 is arranged in a line that surrounds the hub 13. The gears of the gear train 26 are therefore arranged in a line that is substantially circular. The gears of the gear train 26 are arranged sequentially, i.e., in series. The gear train 26 is located between the hub 13 and the outer circumference/tread portion 22 of the wheel 10.

With reference to FIG. 2, the gear train 26 is substantially arrange in a plane, such that the gear train 26 may be substantially planar.

As will be appreciated, the gears of the gear train 16 rotate with respect to the body portion 20/cavity 20a of the wheel 10. The gears of the gear train 26 are, therefore, rotatably mounted to the wheel 10.

In the embodiment illustrated and described here the gears of the gear train 26 are gear shafts, with the gears formed thereon. The gears themselves are spur gears/disc/disk gears/gear wheels. The gear shafts are rotatably mounted on support members 34 (see FIG. 2). The support members 34 are pin members that protrude perpendicularly from the body portion 20 of the wheel 10. The support members 34 are formed with the body portion 20. However, it should be appreciated that they may be attached to the body portion 20. The pin members are substantially cylindrical members that are received by the gear shafts. Each gear shaft therefore includes a cylindrical passage that extends the length of the shaft. In this arrangement the gear shafts are hollow cylinders that are mounted on the support members 34.

Each gear of the gear train 26 rotates about an axis (rotational axis), and each rotational axis is parallel to the rotational axis 11 of the wheel 10.

Each gear shaft of the gear train 26 includes a locking device 36 (an example of a locking device, or securing device) (see FIG. 2) that retains the gear shaft in place on the support member 34. In the embodiment illustrated and described here the locking device 36 is an annular disc that engages with the support member 34 above the gear shaft by an interference fit. The locking device 36 may engage with the support member 34 by a press-fit.

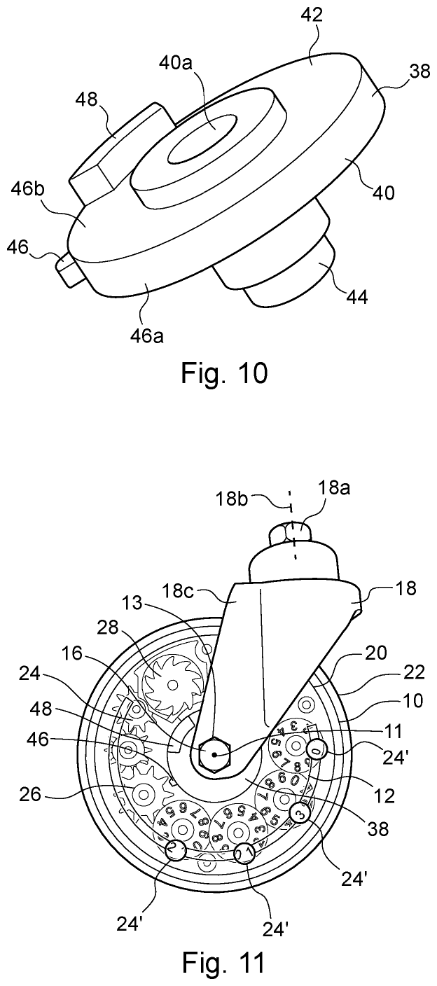

With reference to FIGS. 1, 10 and 11 the wheel 10 further comprises a striking device 38. In the embodiment illustrated and described here the striking device 38 has a body portion 40, which includes a flange, or disc, portion 42, and a cylindrical portion 44 (see FIG. 10). The body portion 40 is configured to receive the axle 16 through an aperture 40a. In this arrangement the striking device 38 is rotatable with respect to the wheel 10, as described further below.

The striking device 38 includes a striking member 46 and an abutment member 48. The striking member 46 is located on an outer edge portion 46a of the disc portion 42 of the striking device 38, and the abutment member 48 is located on an upper surface 46b of the disc portion 42 of the striking device 38, as illustrated in FIG. 10. The striking member 46 and an abutment member 48 are protrusions, protruding portions, which protrude from the striking device 38.

With reference to FIG. 11, when the wheel 10 is mounted to the fork 18, the striking device 38 is arranged such that the abutment member 48 may come into contact with the fork 18. In this arrangement, when the wheel 10 rotates with respect to the fork 18, the striking device 38 does not move with the wheel 10, and is, instead, held in place against the fork 18. In the embodiment illustrated and described here the striking device 38 is not attached to the fork 18, it is merely configured to come into contact with the fork, via the abutment member 48, to prevent it rotating with the wheel 10. The wheel 10 therefore rotates about both the fork 18 and the striking device 38. As described further below, the drive gear 28 of the gear train 26 is struck by the striking member 46 of the striking device 38 once per revolution of the wheel 10.

As illustrated in FIG. 1, the teeth 28a of the drive gear 28 have a striking surfaces 28b. The striking surfaces 28b are configured to present a curved contact surface for engagement with the striking member 46.

The drive gear 28 is arranged such that it partially rotates when struck by the striking member 46. Striking of a gear tooth 28a by the striking member 46 rotates the drive gear 28 by an amount that presents the subsequent, or next, gear tooth 28a for striking. In this arrangement, the striking member 46 strikes each gear tooth 28a of the drive gear 28 as the gear rotates. That is, the striking member 46 strikes each gear tooth 28a of the drive gear 28 consecutively. The striking member 46 strikes the drive gear 28 once per revolution of the wheel 10 relative to the striking device 38/fork 18.

In the embodiment illustrated and described here the gear train 26 includes a drive gear 28, four indicator gears 50, 51, 53 and 55, and three intermediate gears 33, 33 and 35. The gears of the gear train 26 are arranged consecutively. However, it should be appreciated that other gear train arrangements may be possible.

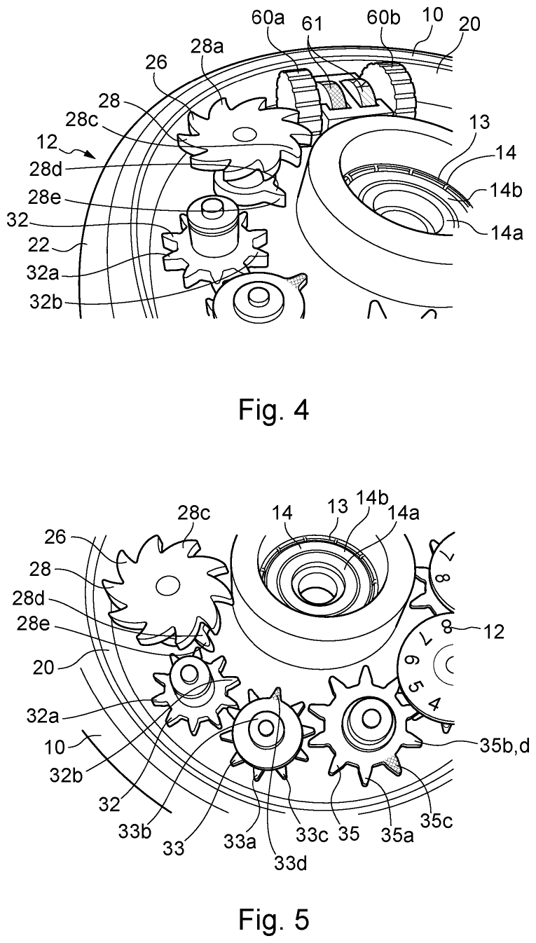

With reference to FIGS. 1 and 3 to 9, in the embodiment illustrated and described here the drive gear 28 has a first gear 28c and a second gear 28d. The first gear 28c is operable by the striking member 46. The first gear 28c includes ten gear teeth 28a. The second gear 28d includes one gear tooth 28e. The second gear 28d drives the first intermediate gear 32. The first and second gears 28c, 28d are spaced apart in the longitudinal direction of the gear shaft.

The first intermediate gear 32 has a gear 32a with ten gear teeth 32b. The first intermediate gear 32 gear drives the second intermediate gear 33.

The second intermediate gear 33 has a first gear 33a and a second gear 33b. The first gear 33a is driven by the gear 32a of the first intermediate gear 32. The first gear 33a includes ten gear teeth 33c and the second gear 33b includes one gear tooth 33d. The second gear 33b drives the third intermediate gear 35. The first and second gears 33a, 33b are spaced apart in the longitudinal direction of the gear shaft.

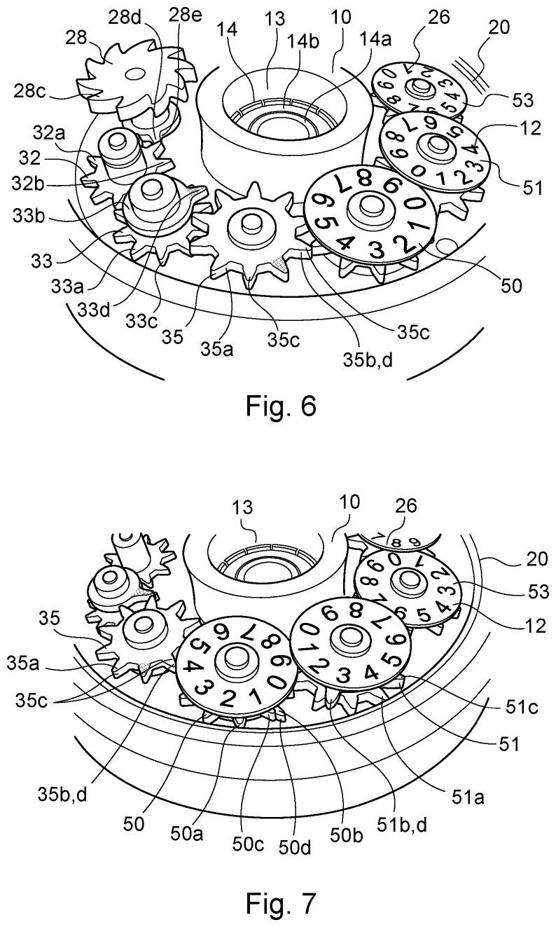

The third intermediate gear 35 has a first gear 35a and a second gear 35b. The first gear 35a is driven by the second gear 33b of the second intermediate gear 33. The first gear 35a includes ten gear teeth 35c and the second gear 35b includes one gear tooth 35d. The second gear 35b drives the first indicator gear 50. The first and second gears 35a, 35b are spaced apart in the longitudinal direction of the gear shaft. It should be noted that in the embodiment illustrated and described here the gear tooth 35d of the second gear 35b is integrally formed with a gear tooth 35c of the first gear 35a, as illustrated in FIG. 6. It should be appreciated that these gears may be separate.

As best illustrated in FIG. 7, the first indicator gear 50 has a first gear 50a and a second gear 50b. The first gear 50a is driven by the second gear 35b of the third intermediate gear 35. The first gear 50a includes ten gear teeth 50c and the second gear 50b includes one gear tooth 50d. The second gear 50b drives the second indicator gear 51. The first and second gears 50a, 50b are spaced apart in the longitudinal direction of the gear shaft.

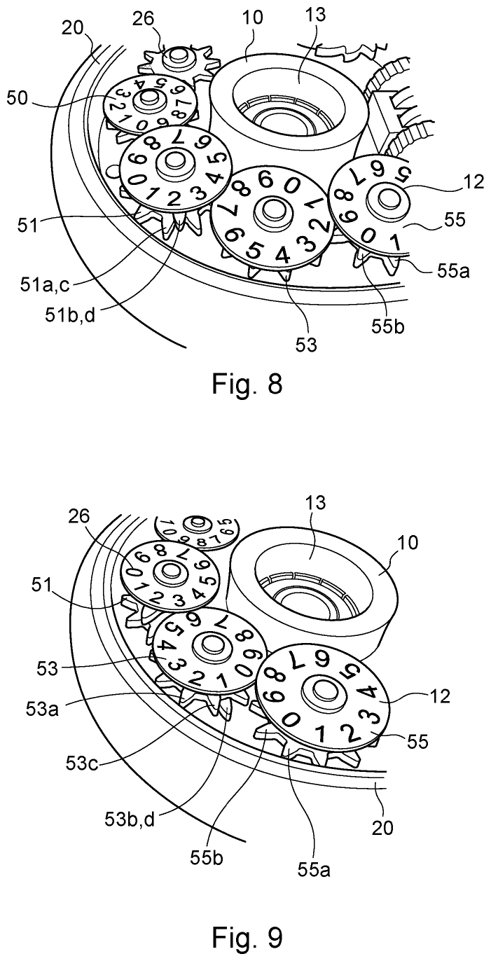

As best illustrated in FIGS. 7 and 8, the second indicator gear 51 has a first gear 51a and a second gear 51b. The first gear 51a is driven by the second gear 50b of the first indicator gear 50. The first gear 51a includes ten gear teeth 51c and the second gear 51b includes one gear tooth 51d. The second gear 51b drives the third indicator gear 53. The first and second gears 51a, 51b are spaced apart in the longitudinal direction of the gear shaft.

As best illustrated in FIG. 9, the third indicator gear 53 has a first gear 53a and a second gear 53b. The first gear 53a is driven by the second gear 51b of the second indicator gear 51. The first gear 53a includes ten gear teeth 53c and the second gear 53b includes one gear tooth 53d. The second gear 53b drives the fourth indicator gear 55. The first and second gears 53a, 53b are spaced apart in the longitudinal direction of the gear shaft.

As best illustrated in FIGS. 8 and 9, the fourth indicator gear 55 has a gear 55a. The gear 55a is driven by the second gear 53b of the third indicator gear 53. The gear 55a includes ten gear teeth 55b.

The gear ratio between the drive gear 28 and the first intermediate gear 32 is ten (10:1). The gear ratio between the first intermediate gear 32 and the second intermediate gear 33 is one (1:1). The gear ratio between the second intermediate gear 33 and the third intermediate gear 35 is ten (10:1). The gear ratio between the third intermediate gear 35 and the first indicator gear 50 is ten (10:1). The gear ratio between the first indicator gear 50 and the second indicator gear 51 is ten (10:1). The gear ratio between the second indicator gear 51 and the third indicator gear 53 is ten (10:1). The gear ratio between the third indicator gear 53 and the fourth indicator gear 55 is ten (10:1).

The first and second gears of the gears of the gear train may be integrally formed with the gear shaft. Also, the first and second gears themselves may be integrally formed.

In the arrangement of the gears of the gear train 26 described above the gears are in discontinuous in contact. That is, the gears of the gear train 26 are arranged such that the gears do not all rotate at the same time, with exception of the first and second intermediate gears 32, 33. Operation of each of the gears after the drive gear 28 is dependent upon a single tooth of the driving gear striking the adjacent gear, which is once per revolution of that gear.

The indicator gears 50, 51, 53 and 55 include indicator devices 50′, 51′, 53′ and 55′ that indicate/represent the distance travelled by the wheel 10 during use. The indicator devices 50′, 51′, 53′ and 55′ are configured to indicate the position of the gears 50, 51, 53 and 55 relative to the body portion 20 of the wheel 10. The indicator devices 50′, 51′, 53′ and 55′ are configured to indicate the position of each gear tooth of the gear relative to the body portion 20 of the wheel 10.

In the embodiment illustrated and described here the indicator devices 50′, 51′, 53′ and 55′ are disc members that are marked with numbers 0 to 9 (an example of an identification marker), each number being associated with a gear tooth of the gear. It should be appreciated that other markers, or symbols, or the like may be used instead of numbers. The indicator devices 50′, 51′, 53′ and 55′ and the cover member 24 of the wheel 10 are arranged such that the identification markers are visible through an aperture 24′, or window, of the cover member 24, as illustrated in FIG. 11.

The indicator devices 50′, 51′, 53′ and 55′ indicate the number of revolutions the gear has undertaken with respect to the body portion 20 of the wheel 10. The identification markers are representative of the distance travelled by the wheel 10 during use. The distance travelled by the wheel 10 is determined by an algorithm that converts the identification markers to a distance.

The tables below provides an example of how the distance travelled by the wheel 10 is determined by the odometer 12. As described above, the circumference of the wheel 10 in the embodiment illustrated and described here is approximately 40 cm.

TABLE 2

| | Indicator | Indicator | Indicator | Indicator |
|---|---|---|---|---|
| Distance (km) | Gear 1 | Gear 2 | Gear 3 | Gear 4 |
| 48.4 | 1 | 2 | 1 | 0 |
| 100 | 0 | 5 | 2 | 0 |
| 264.8 | 2 | 6 | 6 | 0 |
| 1248 | 0 | 2 | 1 | 3 |
| 2476 | 0 | 9 | 1 | 6 |

TABLE 2

| Distance | Indicator | Indicator | Indicator | Indicator |
|---|---|---|---|---|
| (km) | Gear 1 | Gear 2 | Gear 3 | Gear 4 |
| 48.4 | 1 | 2 | 1 | 0 |
| 100 | 0 | 5 | 2 | 0 |
| 264.8 | 2 | 6 | 6 | 0 |
| 1248 | 0 | 2 | 1 | 3 |
| 2476 | 0 | 9 | 1 | 6 |

Table 1 illustrates the distances recorded by the odometer 12 for every revolution of the wheel 10. Colum 0 details the number of revolutions of the wheel 10, starting at the bottom left corner. Column 1 shows the distance recorded by the drive gear 28. As illustrated, after one revolution of the wheel 10, the drive gear 28 performs 1/10^{th} of a turn, which is representative of 0.4 m. After ten revolutions of the wheel 10, the drive gear 28 has completed one full revolution, and has turned the first and second intermediate gears 32, 33 1/10^{th} of a turn, as detailed at the bottom of column 2, and the wheel has travelled 4 m. At this point it should be appreciated that the indicator gears 50, 51, 53, 55 have not yet been turned.

As the wheel 10 continues to revolve, the gear train 26 of the odometer 12 transmits the movement of the drive gear 28 and the intermediate gears 32, 33 and 35 to the indicator gears 50, 51, 53, 55. As detailed in table 1, the odometer 12 is configured such that the distance recorded by the drive gear 28 and the intermediate gears 32, 33 and 35 is “non-visible”. The first visible indication of the distance travelled by the wheel 10 is when the indicator gear 50 registers 1/10^{th} of a revolution, i.e., 0.4 km (see the bottom of column 4 of table 1). At this point the indicator device 50′ of indicator gear 50 will display “1”.

As the wheel 10 continues to revolve, the gears of the gear train 26 of the odometer 12 continues to move with the gear ratios described above and the indicator devices 50′, 51′, 53′ and 55′ display identification markers between “0” and “9” to represent the position of each gear.

Columns 4, 5, 6 and 7 correspond to the indicator gears 50, 51, 53, 55, respectively. As illustrated, in the embodiment illustrated and described here the odometer 12 can measure and display up to 4,000 km before resetting to 0 km.

Table 2 illustrates some example odometer readings and the corresponding distance.

As illustrated in FIG. 1, the wheel 10 comprises a further identification device 60. The identification device 60 is configured to identify one or more parameters, or pieces of information pertaining to the wheel 10, or a vehicle to which it is attached. The information may include the type of vehicle, the last date of reading of the odometer, etc.

The identification device 60 is adjustable, such that a plurality of parameters or pieces of information pertaining to the wheel 10 may identified. In the embodiment illustrated and described here the identification device 60 includes to adjustment members 60a and 60b, which include a plurality of coloured portions 61. Rotation of the adjustment members 60a and 60b allow different colours to be visible through the cover member 24 of the wheel 10. It should be appreciated that symbols, characters, markers, or the like, could also be used, with each representing a parameter, or piece of information pertaining to the wheel 10.

As illustrated, the identification device 60 is located within the cavity 20a of the wheel 10, and is operable through the cover member 24 of the wheel 10 (see FIG. 12).

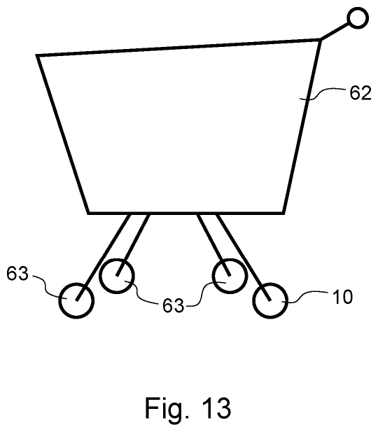

The wheel 10 of the present invention may be used with a vehicle, such as a conveyance or transport vehicle. The vehicle may be configured to transport a load, or loads. The vehicle may be configured to carry objects, or loads. In particular, the vehicle 62 (an example of a wheeled vehicle and a trolley) may be a trolley, cart, shopping trolley, shopping cart, or the like, as illustrated in FIG. 13.

The vehicle 62 may comprise three other wheels 63, the other wheels being normal wheels, i.e., not including an odometer.

In use, when the wheel 10 is used with a vehicle 62, the distance travelled by the wheel 10 (and vehicle 62) is determined by reading the identification markers “0” to “9” of the indicator devices 50′, 51′, 53′ and 55′ of the indicator gears 50, 51, 53, 55. Initially, when the wheel 10 is first installed, or provided with, the vehicle 62, the odometer 12 will have a reading of 0 0 0 0 (i.e., 0 km). The distance travelled by the wheel 10 is determined by performing a second reading of the odometer 12 after a predetermined time interval and subtracting the first reading from the second reading. This operation is repeated for future readings, where the last reading is subtracted from the new reading. Once the odometer 12 resets (“goes round the clock”), this would be noted and 4,000 km may be added to the new reading. This information may, for example, be noted by the coloured portions 61 of the identification device 60.

In use, when the wheel 10 is fitted to a wheeled vehicle 62, such as a supermarket trolley, or the like, each trolley 62 is fitted with a wheel 10 (with fork 18), i.e., a caster/castor. It should be appreciated that the wheel 10 of the present invention may be retro-fitted to an existing trolley 62, or may be included in the manufacture of a new trolley 62. When the wheel 10 is retro-fitted to an existing trolley 62, it is possible to use the same fork, as the wheel 10 may be configured to have identical dimensions to an existing trolley wheel 63. The odometer 12 constantly records the distance covered by the trolley 62. The data from each trolley 62 is then captured and recorded (by, for example, trolley type), which may at the scheduled maintenance period for the trolley 62. The data is then input to a database, or app, that converts the raw data into graphs and charts that show the usage of trolley in distance values. At the point of installation of the wheel 10 to an existing trolley 62 (i.e., removing one of the existing wheels 63 and replacing with a wheel 10 of the present invention), or when a new trolley 62 is delivered with a wheel 10 of the present invention already fitted, a “test” walk around the area where the trolley 62 is used (e.g., a supermarket) is carried out. The test walk simulates normal usage of the trolley 62, i.e., a normal shopping trip around a supermarket, or the like. The date from the test walk is recorded against that area (or supermarket store) to provide a baseline for the total quantity of trips any particular trolley has covered.

For example, once installed on a fleet of trolleys, a trolley is walked from a mid-range trolley bay in the car park, and manoeuvred around the store—as a shopper would, and then returned to a bay in the car park.

A reading is taken and used as a benchmark for this store, e.g., 1 trip=1.25 km for store ‘X’.

This date will then show the following analysis:
What trolley type has been used the most.
What trolley type has been used the least.
What trolley type have not been used at all.
What is the variant between trolley types? (this is important sales data—owing to spend capabilities of shallow and deep basket trolley type variants).
If all trolleys have very high usage, then fleet is most likely too small in numbers, especially if data taken in between quiet trading periods (Christmas/Easter)
If all trolleys have very low usage, then it's most likely there are too many in the fleet.

This list is non-exhaustive, and can be tailored in many variations, but ultimately, it now offers the retailer a defined and prolonged period of usage data to work with, by trolley type, by store.

This solution is also be beneficial to many other applications/industries, as being able to ‘at a glance’ view the distance covered by a piece of equipment, can be very helpful in determining maintenance intervals, lifespan expectancy, comparisons between same equipment types etc. Such alternative applications, or industries, may include:

1. Logistics/distribution—roll cages
2. Dairy logistics—milk cages
3. Airports—Baggage carts

### 4. Railways/Bus Stations—Porter Trolleys

5. Hospitals—beds and all rolling stock
6. Internet picking trolleys—retailers

### 7. Hotels—Porter Trolleys/Linen Trolleys

8. Manufacturing—stock trolleys/work platforms
9. Warehouse ladders/access equipment

The wheel 10, and vehicle 62 (wheeled vehicle), of the present invention provides improved and thus informed management decisions to be made across fleets of wheeled vehicles, which reduces asset purchase costs.

Modifications may be made to the foregoing embodiment without departing from the scope of the present invention. For example, although the striking device 38 has been illustrated and describe above as including one striking member 46, it should be appreciated that it may include two or more striking members.

Furthermore, all the gear ratios have been described above as the gear ratio between the drive gear and the first intermediate gear being ten (10:1), the gear ratio between the first intermediate gear and the second intermediate gear being one (1:1), the gear ratio between the second intermediate gear and the third intermediate gear being ten (10:1), the gear ratio between the third intermediate gear and the first indicator gear being ten (10:1), the gear ratio between the first indicator gear and the second indicator gear being ten (10:1), the gear ratio between the second indicator gear and the third indicator gear being ten (10:1), and the gear ratio between the third indicator gear and the fourth indicator gear being ten (10:1), it should be possible that other gear ratios are possible, such as between five and fifteen, with the objective of the invention being to provide a simple mechanical odometer that represents the distance travelled by the wheel 10.

Also, although the gears have been illustrated and described above as being gear shafts, it should be appreciated that other gear arrangements are possible.

Furthermore, although the striking device 38 has been illustrated and described above as being a mounted to the wheel 10 and capable of abutting against an object (fork 18) to which the wheel 10 is attached, it should be appreciated that the striking device 38 may be configured such that it may be attachable to the object. The striking device 38 may be configured such that it may be attachable to an object, such that, in use, the wheel 10 rotates with respect to the striking device 38. In this arrangement, the striking device 38 is fixed to the object and the wheel 10 rotates about the striking device 38. The drive gear 28 of the gear train 26 is struck by the striking member 46 of the striking device 38 once per revolution of the wheel 10. In this arrangement, the striking device 38 is prevented from rotating with respect to the fork, and the wheel is free to rotate about the striking device.

Furthermore, although the gear shafts have been illustrated and described above as being integrally formed, it should be appreciated that they may be formed in two parts, the two parts being configured to interlock and rotate as one when driven.

1. A wheel, the wheel comprising:
an odometer, the odometer being located within the wheel and including a gear train, the gear train comprising:
a drive gear; and
at least one indicator gear,
wherein the drive gear is configured to be operable by a striking member, and the at least one indicator gear includes an indicator device, the indicator device being configured to indicate the distance travelled by the wheel during use.

2. The wheel of claim 1, wherein the wheel includes a body portion having a cavity, and the odometer is located in the cavity.

3. The wheel of claim 2, wherein the cavity is annular.

4. The wheel of claim 2, wherein the wheel further comprises an opaque, transparent, or translucent cover member, the cover member being arranged to cover the cavity.

5. The wheel of claim 1, wherein the gears of the gear train are rotatably mounted to the wheel.

6.-7. (canceled)

8. The wheel of claim 1, wherein the gears of the gear train are gear shafts, the gear shafts being mountable to support members on the wheel.

9. The wheel of claim 1, wherein the drive gear is configured such that striking of a gear tooth by a striking member rotates the drive gear by an amount that presents the subsequent gear tooth for striking, such that a striking member strikes each gear tooth of the drive gear as the gear rotates.

10.-13. (canceled)

14. The wheel of claim 1, wherein the gear train further comprises one or more intermediate gears, the one or more intermediate gears being located between the drive gear and the at least one indicator gear.

15.-17. (canceled)

18. The wheel of claim 8, wherein the drive gear has a first gear and a second gear, the first gear being operable by a striking member, and the second gear being arranged to drive a first intermediate gear.

19. The wheel of claim 9, wherein the first intermediate gear is arranged to drive a second intermediate gear.

20. The wheel of claim 10, wherein the second intermediate gear has a first gear and a second gear, the first gear being driven by the gear of the first intermediate gear, and the second gear being arranged to drive a third intermediate gear.

21. The wheel of claim 11, wherein the third intermediate gear has a first gear and a second gear, the first gear being driven by the second gear of the second intermediate gear shaft, and the second gear being arranged to drive the first indicator gear.

22. The wheel of claim 12, wherein the first indicator gear has a first gear and a second gear, the first gear being driven by the second gear of the third intermediate gear shaft, and the second gear being arranged to drive the second indicator gear.

23. The wheel of claim 13, wherein the second indicator gear has a first gear and a second gear, the first gear being driven by the second gear of the first indicator gear, and the second gear being arranged to drive the third indicator gear.

24. The wheel of claim 14, wherein the third indicator gear has a first gear and a second gear, the first gear being driven by the second gear of the second indicator gear, and the second gear being arranged to drive the fourth indicator gear.

25. The wheel of claim 15, wherein the fourth indicator gear is driven by the second gear of the third indicator gear.

26. (canceled)

27. The wheel of claim 1, wherein the indicator device is configured to associate an identification marker with each gear tooth of the gear, the indicator device thus indicating a number of revolutions the gear has undertaken with respect to the wheel.

28. (canceled)

29. The wheel of claim 1, wherein the wheel further comprises a further identification device, the identification device being configured to identify one or more parameters, or pieces of information pertaining to the wheel.

30. A vehicle comprising a wheel, the wheel comprising:
an odometer, the odometer being located within the wheel and including a gear train, the gear train comprising:
a drive gear; and
at least one indicator gear,
wherein the drive gear is configured to be operable by a striking member, and the at least one indicator gear includes an indicator device, the indicator device being configured to indicate the distance travelled by the wheel during use.

31. A method of determining the distance travelled by a vehicle, the method comprising the steps of:
providing a vehicle, wherein a wheel of the vehicle includes an odometer located within the wheel, the odometer including an indicator device configured to indicate the distance travelled by the wheel during use;
recording a first reading of the odometer;
recording a second reading of the odometer, the second reading being carried out after a predetermined time interval; and
determining the distance travelled by the wheel between the first reading and the second reading.

32. (canceled)
